(19) United States
(12) Patent Application Publication
(10) Pub. No.: US 2026/0170524 A1
(43) Pub. Date: Jun. 18, 2026

(54) JU_ORCA

(71) Applicant: John Rogers Uhrin, JR., Bainbridge Island, WA (US)

(72) Inventor: John Rogers Uhrin, JR., Bainbridge Island, WA (US)

(21) Appl. No.: 18/982,936

(22) Filed: Dec. 16, 2024

(51) Int. Cl. G06Q 30/0201; G06F 8/30; G06F 8/41; G06Q 10/0631; G06Q 50/08

(52) U.S. Cl. CPC G06Q 30/0206; G06F 8/315; G06F 8/427; G06Q 10/06311; G06Q 50/08

(57) ABSTRACT

This invention relates to an AI-driven chatbot system designed to generate accurate construction cost estimates by leveraging Building Information Modeling (BIM) model data encoded in JSON. The system employs deep learning algorithms to analyze BIM data, interact with users, and provide cost insights. It is connected to a centralized cost database, ensuring up-to-date and contextually relevant cost information.

### BACKGROUND

The construction industry often faces challenges in accurately estimating project costs due to the complexity and variability of project designs. Traditional methods rely heavily on manual input and static data, leading to inefficiencies and inaccuracies. This invention aims to improve cost estimation by using advanced Al techniques to process dynamic BIM data.

### SUMMARY OF THE INVENTION

The invention is a chatbot system that uses deep learning to interpret BIM model JSON data and provide real-time construction cost estimates. It interfaces with a centralized cost database to ensure the accuracy and relevance of cost data. The system is designed to interact with users, answer queries, and refine estimates based on user feedback and additional data inputs.

### BRIEF DESCRIPTION OF THE DRAWINGS

FIG. 1 is a systems data flow/product road map illustrating how the inputs and outputs are connected.

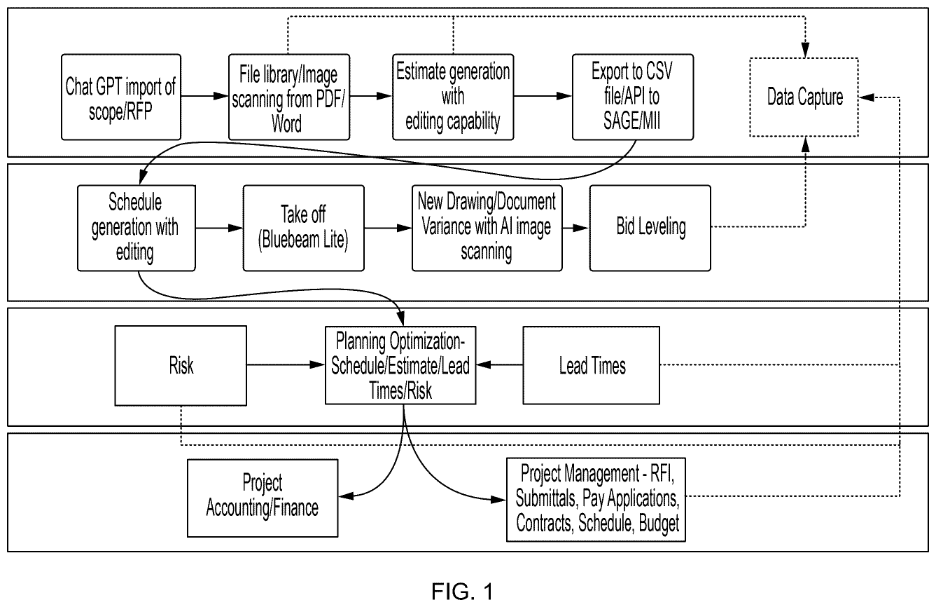

### DETAILED DESCRIPTION

### System Architecture

a. Al Chatbot Module: Utilizes natural language processing (NLP) to interact with users and understand queries related to construction cost estimation.
b. Deep Learning Engine: Analyzes BIM model JSON data to extract relevant parameters for cost estimation.
c. Centralized Cost Database: Stores and regularly updates cost data for various construction materials, labor, and equipment.
d. Integration Layer: Facilitates communication between the chatbot, deep learning engine, and cost database.

### Functionality

a. Data Extraction: The system parses BIM model JSON data to identify key parameters such as materials, dimensions, and project phases.
b. Cost Estimation: Uses deep learning models trained on historical data to compute cost estimates, considering factors like location, project scale, and market trends.
c. Scheduling: Uses estimate to generate a schedule for construction based on preceding items and linking priorities combined with total manhours and equipment hours for each task.
d. Planning: Optimizes duration and costs for each project based on generated estimate and schedule.
e. Risk: Identifies/determines project risk items based on lead times, environmental risks, market risks, geopolitical risks and generates a risk registry and applies values to run a statistical model for risk assessment.
f. Value Engineering: Identifies tasks/line items/design features and materials that can be replaced or changed to save time and money on a project.
g. User Interaction: The chatbot answers user queries, provides explanations for cost estimates, and updates estimates based on additional user-provided data.
h. Feedback Loop: Collects user feedback to improve the accuracy of future estimates through continuous learning along with schedules/planning/risk/value engineering.

1. A system for generating construction cost estimates, comprising a data extraction module configured to parse Building Information Modeling (BIM) model JavaScript Object Notation (JSON) data to identify the following parameters: materials, dimensions, and project phases.

2. The system of claim 1, further comprising a cost estimation module configured to interact with deep learning models trained on historical data to compute cost estimates, taking into account factors such as location, project scale, and market trends.

3. The system of claim 2, wherein the cost estimation module is linked to a centralized database to enhance accuracy and currency of cost estimates by sourcing data on material costs, labor rates, and equipment expenses.

4. The system of claim 1, further comprising a scheduling module configured to create a construction schedule based on cost estimates, linking priorities along with total man-hours and equipment hours for each task.

5. The system of claim 1, further comprising planning module configured to optimize project duration and costs based on generated estimates and schedules.

6. The system of claim 1, further comprising a risk assessment module configured to identify project risks related to lead times, environmental factors, market conditions, and geopolitical issues, wherein the risk assessment module is further configured to create a risk registry for statistical evaluation.

7. The system of claim 1, further comprising a value engineering module configured to identify tasks, line items, design features, and materials that can be replaced or modified to reduce project time and costs.

8. The system of claim 1, further comprising a user interaction module configured to address user queries concerning construction costs and project planning, wherein the user interaction model is further configured to explain cost estimates and schedules, and to update estimates based on additional user-provided information.

9. The system of claim 1, further comprising a feedback loop module configured to gather user feedback to improve the accuracy of future estimates, schedules, planning, risk assessments, and value engineering processes through continual learning.

10. The system of claim 4, wherein the scheduling module is configured to create a construction schedule that considers cost estimates and project priorities, optimizing project duration and costs based on estimates and schedules, assessing project risks and producing a risk registry for statistical analysis, suggesting value engineering solutions to enhance project efficiency, and engaging with users to refine estimates and plans based on their feedback.
